(19) United States
(12) Patent Application Publication
(10) Pub. No.: US 2013/0115432 A1
(43) Pub. Date: May 9, 2013

(54) LAYERED STRUCTURE, PROCESS OF APPLYING AN IMAGE LAYER, AND PROCESS OF USING A LAYERED STRUCTURE

(71) Applicant: IPT, LLC, Akron, OH (US)

(72) Inventor: Robert A. HARRIS, Akron, OH (US)

(73) Assignee: IPT, LLC, Akron, OH (US)

(21) Appl. No.: 13/719,384

(22) Filed: Dec. 19, 2012

Related U.S. Application Data
(63) Continuation-in-part of application No. 12/649,036, filed on Dec. 29, 2009, now Pat. No. 8,337,987.

(51) Int. Cl. B05D 3/06

(52) U.S. Cl. CPC B05D 3/067
USPC 428/201; 427/532; 427/258

(57) ABSTRACT

A layered structure, a process of applying an image layer to a substrate, and a process of using a layered structure are disclosed. The layered structure having an image layer is applied to a substrate. The image layer is formed by a transfer foil process, a digital printing process, or a combination thereof. The image layer includes one or both of a radiation-cured coating and an amine-cured coating. The application process includes positioning a substrate, applying an image layer to the substrate, and applying a coating to the image layer. The process of using a layered structure includes positioning the layered structure in an exterior environment, applying an image to an image layer by a transfer foil process, a digital printing process, or a combination thereof, and applying the coating to the image layer, the coating being radiation-cured, amine-cured, or a combination thereof.

### PRIORITY

The present application is a continuation-in-part patent application, claiming priority to U.S. application Ser. No. 12/649,036, filed Dec. 29, 2009, and issued as U.S. Pat. No. 8,337,987, which is hereby incorporated by reference in its entirety.

### FIELD OF THE INVENTION

The present disclosure generally relates to layered structures and processes of fabricating and using layered structures. More particularly, the present invention is directed to layered structures with an image layer formed by a transfer foil process and/or a digital printing process.

### BACKGROUND OF THE INVENTION

Many wood products are aesthetically pleasing to many consumers. Some wood products may be unavailable, expensive, or have undesirable features. Producing wood products having aesthetically pleasing qualities may, therefore, be impractical or expensive.

Wood products finished on site at a construction site may be especially expensive. Labor costs associated with wood finishing at a construction site may be high due to the inability to use manufacturing systems for finishing the materials. However, finishing materials utilized with these manufacturing systems often do not provide desirable exterior durability properties. For example, the finishing materials may yellow, may harden, may fade, and/or may permit moisture to travel through the finishing materials. Alternatively, finishing materials with desirable properties may be harmful for the environment by having a high concentration of evaporable solvents.

A layered structure, process of applying an image layer, and a process of using a layered structure that do not suffer from one or more of the above drawbacks would be desirable in the art.

### SUMMARY OF THE INVENTION

In an exemplary embodiment, a layered structure having an image layer is applied to a substrate. The image layer is formed by a transfer foil process, a digital printing process, or a combination thereof. The image layer includes one or both of a radiation-cured coating and an amine-cured coating.

In another exemplary embodiment, an application process includes positioning a substrate, applying an image layer to the substrate, and applying a coating to the image layer. The image layer includes an image formed by a transfer foil process, a digital printing process, or a combination thereof. The coating is a radiation-cured, an amine-cured, or a combination thereof.

In another exemplary embodiment, a process of using a layered structure includes positioning the layered structure in an exterior environment, applying an image to an image layer by a transfer foil process, a digital printing process, or a combination thereof, and applying the coating to the image layer, the coating being radiation-cured, amine-cured, or a combination thereof. The layered structure includes a substrate and an image layer applied to the substrate.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 shows an exemplary layered structure according to an embodiment of the disclosure.

Wherever possible, the same reference numbers will be used throughout the drawings to represent the same parts.

### DETAILED DESCRIPTION OF THE INVENTION

Provided are a layered structure, a process of applying an imaged layer, and a process of using a layered structure. Embodiments of the present disclosure, in comparison to other structures and processes not having one or more of the features disclosed hereinafter, permit use of material in exterior environments, reduce or eliminate yellowing in exterior environments, reduce or eliminate chalking in exterior environments, reduce or eliminate delamination in exterior environments, augment durability (for example, by increasing Taber abrasion properties), or a combination thereof.

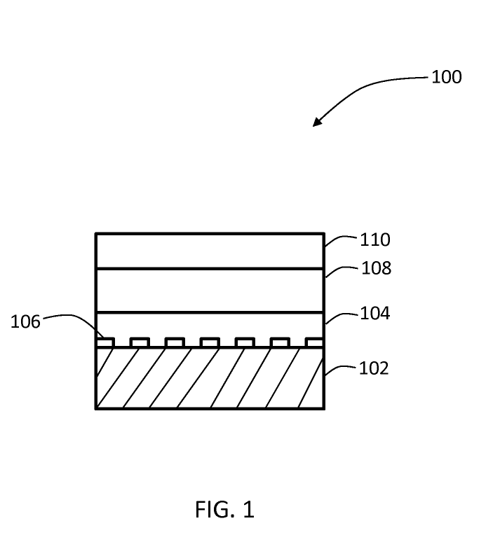

Referring to FIG. 1, a layered structure 100 is or includes siding, decking, railing, fencing, trim, any other suitable building material, or a combination thereof. The layered structure includes a substrate 102 and an image layer 104 applied to the substrate 102. In one embodiment, the substrate 102 is polypropylene, polyethylene, or polyvinyl chloride. In one embodiment, the layered structure 100 is an exterior structure.

The image layer 104 includes an image 106, for example, formed by a reflective ink 108 as is further described in U.S. patent application Ser. No. 12/649,036, filed Dec. 29, 2009, and issued as U.S. Pat. No. 8,337,987, which is hereby incorporated by reference in its entirety. The image 106 is any suitable image, such as, a wood grain pattern, a logo, a design, a natural looking appearance, a landscape, images of buildings and structures, or a combination thereof.

The image layer 104 is formed by one or both of a transfer foil process and a digital printing process, thereby including properties and features not available with other processes. For example, in sublimation processes, a solid material from on a transfer material is converted into gas, which converts into solid upon contacting a surface material. Such processes are limited to materials capable of remaining intact after being converted into gas from a solid and/or capable of traveling through any coatings present. The transfer foil process and the digital printing process are not limited to such materials and/or have physical distinctions based upon such an application technique, for example, digital images can be made to simulate three-dimensional images. Likewise, gravure-application processes result in limits in design based upon gravure-designs and/or include surface features resulting from the surface tension of the surface and/or materials applied to the surface. The transfer foil process and/or the digital printing process have physical distinctions based upon such an application technique.

In one embodiment, the transfer foil process includes a transfer foil (not shown) that includes a reverse-image of the image for the image layer 104 on a carrier material/layer (not shown), such as a Mylar backing. The transfer foil is applied to the substrate 102, for example, directly on the substrate 102 or on one or more layers on the substrate 102. The transfer foil is heated and pressure is applied, for example, by using a heated roller and pressure in an in-line manufacturing process. Upon reaching a predetermined temperature and/or pressure, the image on the transfer foil transfers from the transfer foil to form the image layer 104 or a portion of the image layer 104.

In one embodiment, the digital printing process includes a digital printer (not shown) that applied the image to form the image layer 104. The digital printer uses any suitable digital printing technology capable of applying ink to form the image layer 104.

As will be appreciated, the transfer foil process and/or the digital printing process are capable of single-step application or multi-step application. In single-step application embodiments, the image layer 104 is formed by a single application of the image. In such embodiments, the application of multiple colors and/or multiple patterns is all at once. In multi-step application embodiments, the image layer 104 is formed by sequential or concurrent application of portions of the image. For example, in such embodiments, the application of multiple colors is accomplished with one or more colors being applied separately from one or more other colors, such as in a sequence, and/or with one or more patterns being applied separately from one or more other patterns.

In one embodiment, the image layer 104 includes or is a vinyl layer, or has a composition, for example, by weight, as follows:

TABLE 1

| | |
|---|---|
| 4-6% | IR Reflective Pigment |
| 1.5-2.5% | Color Chelator |
| 17-19% | Plasticizer |
| 1.5-2.5% | Stabilizer |
| 67-72% | Lubricant |

The image layer 104 is any suitable thickness permitting the layered structure 100 to be used for intended exterior applications. Suitable thicknesses include, but are not limited to, being between about 0.1 mil and about 2 mils, between about 0.5 mils and about 2 mils, between about 0.5 mils and about 1.5 mils, between about 0.5 mils and about 1 mil, between about 0.1 mil and about 1 mil, between about 0.1 mil and about 1.5 mils, between about 0.1 mils and about 0.5 mils, or any suitable combination, sub-combination, range, or sub-range therein.

The image layer 104 includes an IR reflective pigment, by weight percent, of about 4 percent to about 6 percent, about 4 percent to about 5 percent, about 5 percent to about 6 percent, about 4 percent, about 5 percent, about 6 percent, or any combination, or sub-combination therein. The image layer 104 includes a color chelator, by weight percent, of about 1.5 percent to about 2.5 percent, of about 1.5 percent to about 1.75 percent, of about 1.75 percent to about 2.25 percent, of about 2.0 percent to about 2.5 percent, about 1.5 percent, about 1.75 percent, about 2.0 percent, about 2.25 percent, about 2.5 percent, or any suitable combination, or sub-combination therein. The image layer 104 includes a plasticizer, by weight percent, of about 17 percent to about 19 percent, of about 17 percent to about 18 percent, of about 18 percent to about 19 percent, about 17 percent, about 18 percent, about 19 percent, or any suitable combination, or sub-combination therein. The image layer 104 includes a stabilizer, by weight percent, of about 1.5 percent to about 2.5 percent, of about 1.5 percent to about 1.75 percent, of about 1.75 percent to about 2.25 percent, of about 2.0 percent to about 2.5 percent, about 1.5 percent, about 1.75 percent, about 2.0 percent, about 2.25 percent, about 2.5 percent, or any suitable combination, or sub-combination therein. The image layer 104 includes a lubricant, by weight percent, of about 67 percent to about 72 percent, of about 67 percent to about 70 percent, of about 70 percent to about 72 percent, about 67 percent, about 70 percent, about 72 percent, or any combination, or sub-combination therein.

In one embodiment, the layered structure 100 includes an adhesive (not shown), for example, positioned on the image layer 104 and/or the substrate 102 (such as on the side proximal to the image layer 104 or the side distal from the image layer 104). Additionally or alternatively, the adhesive is gravure printed in the foil. In one embodiment, the adhesive is heat-activated and/or a polyurethane. In one embodiment, the adhesive is solvent-based, having, for example, hydrocarbon, chlorinated hydrocarbon, or water-based solvent. In another embodiment, the adhesive is heat-activated, for example, hot melts, polyesters, polyacrylates, or other polymeric materials having a sufficiently elevated melting point, such that, the heat-activated adhesive remains solid, crystalline, or semi-crystalline during the service conditions of the layered structure 100. In another embodiment, the heat-activated adhesive of the layered structure 100 is activated by infrared energy, microwave energy, or induction energy, whereby the heat transfer layer absorbs the energy, thus causing the heat-activated adhesive to melt and form a bond with the substrate 102 adjacent to the heat-activated adhesive. In another embodiment, the adhesive is a multi-component, reactive mixture, for example, a two-part epoxy or urethane.

In one embodiment, the layered structure 100 includes a release layer (not shown) applied to at least a portion of the adhesive. In one embodiment, the release layer is a paper or plastic film having a coating of silicone or polytetrafluoroethylene applied thereto, such that, the coating of silicone or polytetrafluoroethylene abuts the adhesive. In one embodiment, the adhesive adjacent to the release layer is pressure-sensitive. In another embodiment, the release layer is removed prior to placement of the layered structure 100 onto a substrate.

A coating 110 is applied to the image layer 108. The coating 110 is any suitable thickness capable of protecting the substrate 102 and/or the reflective ink 108. Suitable thicknesses include, but are not limited to, between about 0.5 mil and about 10 mils, between about 1 mil and about 2 mils (for example, as in non-wear surface applications) between about 2 mils and about 5 mils, between about 4 mils and about 8 mils, between about 8 mils and about 10 mils (for example, as in decking applications) or any suitable combination, sub-combination, range, or sub-range therein. In one embodiment, coating thickness is selected to provide a predetermined wear resistance, weatherability, stain resistance, or combination thereof.

The coating 110 is a radiation-cured coating (for example, a UV-cured coating and/or an EB-cured coating) and/or an amine-cured coating. One suitable amine-cured coating embodiment is an amine-cured and thermally-accelerated aliphatic polyurea. In one embodiment, the uncured composition for the coating 110 is, by part volume, about as follows:

TABLE 2

| | |
|---|---|
| 20-40 | Secondary Amines |
| 0.1-5.0 | Surface toughening agents |
| 0.5-3.0 | Defoaming agents |
| 15-50 | Parachlorobenzotrifluoride |
| 10-40 | Polyisocyanate |
| 1.0-15.0 | Fumed silica |
| 2.0-5.0 | UV stabilizer package |

The uncured composition for the coating 110 includes secondary amines, by volume percent, of about 20 percent to about 40 percent, of about 20 percent to about 25 percent, of about 20 percent to about 30 percent, of about 25 percent to about 35 percent, of about 30 percent to about 40 percent, about 20 percent, about 25 percent, about 30 percent, about 35 percent, about 40 percent, or any suitable combination, or sub-combination therein. The uncured composition for the coating 110 includes surface toughening agents, by volume percent, of about 0.1 percent to about 5.0 percent, of about 0.1 percent to 1.0 percent, of about 1.0 percent to about 2.0 percent, of about 2.5 percent to 3.0 percent, of about 3.0 percent to about 4.0 percent, of about 3.5 percent to about 4.5 percent, of about 4.0 percent to about 5.0 percent, about 0.1 percent, about 0.5 percent, about 1.0 percent, about 2.0 percent, about 2.5 percent, about 3.0 percent, about 3.5 percent, about 4.0 percent, about 4.5 percent, about 5.0 percent, or any suitable combination, or sub-combination therein. The uncured composition for the coating 110 includes defoaming agents, by volume percent, of about 0.5 percent to 3.0 percent, of about 0.5 percent to 1.0 percent, of about 1.0 percent to about 2.0 percent, of about 2.5 percent to about 3.0 percent, about 0.5 percent, about 1.0 percent, about 1.5 percent, about 2.0 percent, about 2.5 percent, about 3.0 percent, or any suitable combination, or sub-combination therein. The uncured composition for the coating 110 includes parachlorobenzotrifluoride, by volume percent, of about 15 percent to about 50 percent, of about 15 percent to about 20 percent, of about 25 percent to about 30 percent, of about 20 percent to about 40 percent, of about 35 percent to about 50 percent, about 15 percent, about 20 percent, about 25 percent, about 30 percent, about 35 percent, about 40 percent, about 45 percent, about 50 percent, or any suitable combination, or sub-combination therein. The uncured composition for the coating 110 includes fumed silica, by volume percent, of about 1.0 percent to about 15.0 percent, of about 1.0 percent to about 3.0 percent, of about 2.5 percent to about 5.0 percent, of about 5.0 percent to about 7.5 percent, of about 5.0 percent to about 10.0 percent, of about 10.0 percent to about 15.0 percent, about 1 percent, about 3 percent, about 5 percent, about 8 percent, about 10 percent, about 13 percent, about 15 percent, or any suitable combination, or sub-combination therein. The uncured composition for the coating 110 includes UV stabilizer, by volume percent, of about 2.0 percent to about 5.0 percent, of about 2.0 percent to about 2.5 percent, of about 3.0 percent to about 4.0 percent, of about 3.5 percent to about 4.5 percent, of about 4.0 percent to about 5.0 percent, about 2.0 percent, about 2.5 percent, about 3.0 percent, about 3.5 percent, about 4.0 percent, about 4.5 percent, about 5.0 percent, or any suitable combination, or sub-combination therein.

In one embodiment, the uncured composition for the coating 110 is, by part volume, as follows:

TABLE 3

| | |
|---|---|
| 0.1-5.0 | Aliphatic Polyurea |
| 5.0-25.0 | Cyclohexanone |
| 10.0-30.0 | Solvent |
| 10.0-45.0 | Polyester Resin |
| 2.0-10.0 | UV Stabilizer Package |
| 0.25-2.0 | Defoaming agent |
| 0.25-2.0 | Surface toughening agents |
| 0.5-2.0 | Monomer |
| 0.5-3.0 | Polyol |
| 0.1-10.0 | Fumed silica |
| 10.0-35.0 | Resin |

The uncured composition for the coating 110 includes aliphatic polyurea, by volume percent, of about 0.1 percent to about 5.0 percent, of about 0.1 percent to 1.0 percent, of about 1.0 percent to about 2.0 percent, of about 2.5 percent to 3.0 percent, of about 3.0 percent to about 4.0 percent, of about 3.5 percent to about 4.5 percent, of about 4.0 percent to about 5.0 percent, about 0.5 percent, about 1.0 percent, about 2.0 percent, about 2.5 percent, about 3.0 percent, about 3.5 percent, about 4.0 percent, about 4.5 percent, about 5.0 percent, or any suitable combination, or sub-combination therein. The uncured composition for the coating 110 includes cyclohexanone, by volume percent, of about 5.0 percent to about 25.0 percent, of about 5.0 percent to about 10.0 percent, of about 10.0 percent to about 15.0 percent, of about 15.0 percent to about 20.0 percent, of about 20.0 percent to about 25.0 percent, about 5.0 percent, about 10.0 percent, about 15.0 percent, about 20.0 percent, about 25.0 percent, or any suitable combination, or sub combination therein. The uncured composition for the coating 110 includes solvent, by volume percent, of about 10.0 percent to about 30.0 percent, of about 10.0 percent to about 15.0 percent, of about 15.0 percent to about 20.0 percent, of about 20.0 percent to about 25.0 percent, of about 25.0 percent to about 30.0 percent, about 10.0 percent, about 15.0 percent, about 20.0 percent, about 25.0 percent, about 30.0 percent, or any suitable combination, or sub-combination therein. The uncured composition for the coating 110 includes polyester resin, by volume percent, of about 10.0 percent to about 45.0 percent, of about 10.0 percent to about 15.0 percent, of about 15.0 percent to about 20.0 percent, of about 20.0 percent to about 25.0 percent, of about 25.0 percent to about 30.0 percent, about 30.0 percent to about 35.0 percent, about 35.0 percent to about 40.0 percent, of about 40.0 percent to about 45.0 percent, about 10.0 percent, about 15.0 percent, about 20.0 percent, about 25.0 percent, about 30.0 percent, about 35.0 percent, about 40.0 percent, about 45.0 percent, or any suitable combination, or sub-combination therein. The uncured composition for the coating 110 includes UV stabilizer, where the UV stabilizer includes an amine, is present by volume percent, of about 2.0 percent to about 10.0 percent, of about 2.0 percent to about 2.5 percent, of about 2.5 percent to about 5.0 percent, of about 5.0 percent to about 7.5 percent, of about 7.5 percent to about 10.0 percent, about 2.0 percent, about 2.5 percent, about 5.0 percent, about 7.5 percent, about 10.0 percent, or any suitable combination, or sub-combination therein. The uncured composition for the coating 110 includes defoamer, by volume percent, of about 0.25 percent to about 2.0 percent, of about 0.25 percent to about 0.50 percent, of about 0.50 percent to about 1.0 percent, of about 1.5 percent to about 2.0 percent, about 0.25 percent, about 0.50 percent, about 1.0 percent, about 1.5 percent, about 2.0 percent, or any suitable combination, or sub-combination therein. The uncured composition for the coating 110 includes surface toughening agents, by volume percent, of about 0.25 percent to about 2.0 percent, of about 0.25 percent to about 0.50 percent, of about 0.5 percent to about 1.0 percent, of about 1.5 percent to about 2.0 percent, about 0.25 percent, about 0.5 percent, about 1.0 percent, about 1.5 percent, about 2.0 percent, or any suitable combination, or sub-combination therein. The uncured composition for the coating 110 includes monomer, by volume percent, of about 0.5 percent to about 2.0 percent, of about 0.5 percent to about 1.0 percent, of about 1.5 percent to about 2.0 percent, about 0.25 percent, about 0.5 percent, about 1.0 percent, about 1.5 percent, about 2.0 percent, or any suitable combination, or sub-combination therein. The uncured composition for the coating 110 includes polyol, by volume percent, of about 0.5 percent to about 3.0 percent, of about 0.5 percent to about 1.0 percent, of about 1.5 percent to about 2.0 percent, of about 2.5 percent to about 3.0 percent, about 0.25 percent, about 0.5 percent, about 1.0 percent, about 1.5 percent, about 2.0 percent, about 2.5 percent, about 3.0 percent, or any suitable combination, or sub-combination therein. The uncured composition for the coating 110 includes fumed silica, by volume percent, of about 0.1 percent to about 10.0 percent, of about 0.1 percent to about 1.0 percent, of about 1.0 percent to about 5.0 percent, of about 5.0 percent to about 7.5 percent, of about 5.0 percent to about 10.0 percent, about 0.01 percent, about 1.0 percent, about 5.0 percent, about 7.5 percent, about 10.0 percent, or any suitable combination, or sub-combination therein. The uncured composition for the coating 110 includes resin, by volume percent, of about 10.0 percent to about 35.0 percent, of about 10.0 percent to about 15.0 percent, of about 10.0 percent to about 20.0 percent, of about 20.0 percent to about 25.0 percent, of about 25.0 percent to about 30.0 percent, of about 30.0 percent to about 35.0 percent, about 10.0 percent, about 15.0 percent, about 20.0 percent, about 25.0 percent, about 30.0 percent, about 35.0 percent, or any suitable combination, or sub-combination therein.

In one embodiment, the uncured composition for the coating 110 is, by weight, as follows:

TABLE 4

| | |
|---|---|
| 88-92% | Urethane Acrylate Blend |
| 2-2.5% | Alumina nanoparticles |
| 3.5-3.7% | Matting agent |
| 0.3-0.7% | Light stabilizer |
| 0.3-0.7% | UV absorber |
| 2.5-3.5% | Photonitiator |

The uncured composition for the coating 110 includes urethane acrylate blend, by volume percent, of about 88 percent to about 92 percent, of about 88 percent to about 90 percent, of about 90 percent to about 92 percent, about 88 percent, about 90 percent, about 92 percent, or any suitable combination, or sub-combination therein. The uncured composition for the coating 110 includes alumina nanoparticles, by volume percent, of about 2.0 percent to about 2.5 percent, about 2.0 percent to about 2.25 percent, about 2.25 percent to about 2.5 percent, about 2.0 percent, about 2.25 percent, about 2.5 percent, or any suitable combination, or sub-combination therein. The uncured composition for the coating 110 includes matting agent, by volume percent, of about 3.5 percent to about 3.7 percent, about 3.5 percent, about 3.6 percent, about 3.7 percent, or any suitable combination, or sub-combination therein. The uncured composition for the coating 110 includes light stabilizer, by volume percent, of about 0.3 percent to about 0.7 percent, of about 0.3 percent to about 0.5 percent, of about 0.5 percent to about 0.7 percent, about 0.3 percent, about 0.5 percent, about 0.7 percent, or any suitable combination, or sub-combination therein. The uncured composition for the coating 110 includes UV absorber, by volume percent, of about 0.3 percent to about 0.7 percent, of about 0.3 percent to about 0.5 percent, of about 0.5 percent to about 0.7 percent, about 0.3 percent, about 0.5 percent, about 0.7 percent, or any suitable combination, or sub-combination therein. The uncured composition for the coating 110 includes photo initiator, by volume percent, of about 2.5 percent to about 3.5 percent, of about 2.5 percent to about 3.0 percent, of about 3.0 percent to about 3.5 percent, about 2.5 percent, about 3.0 percent, about 3.5 percent, or any suitable combination, or sub-combination therein.

While the disclosure has been described with reference to a preferred embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

What is claimed is:

1. A layered structure, comprising:
a substrate;
an image layer applied to the substrate, the image layer comprising an image, the image layer being formed by one or both of a transfer foil process and a digital printing process; and
a coating applied to the image layer, the coating being one or both of a radiation-cured coating and an amine-cured coating.

2. The layered structure of claim 1, wherein the image layer is formed by a reflective ink.

3. The layered structure of claim 1, wherein the image layer includes an IR reflective pigment, a color chelator, a plasticizer, a stabilizer, and a lubricant.

4. The layered structure of claim 1, wherein the image layer includes a vinyl layer.

5. The layered structure of claim 1, wherein the image layer has a thickness of less than about 1 mil.

6. The layered structure of claim 1, wherein the image layer includes an adhesive.

7. The layered structure of claim 1, wherein the image layer is applied by the transfer foil process.

8. The layered structure of claim 7, wherein the transfer process includes using a heated roller and pressure.

9. The layered structure of claim 7, wherein the transfer process includes using a carrier layer.

10. The layered structure of claim 1, wherein the coating is an amine-cured and thermally-accelerated aliphatic polyurea.

11. The layered structure of claim 1, wherein the coating is from an uncured composition of secondary amines, surface toughening agents, defoaming agents, parachlorobenzotrifluoride, polyisocyanate, fumed silica, and UV stabilizer.

12. The layered structure of claim 1, wherein the coating is an uncured composition of aliphatic polyurea, cyclohexanone, solvent, polyester resin, UV stabilizer, defoamer, surface toughening agents, monomer, polyol, fumed silica, and resin.

13. The layered structure of claim 1, wherein the coating is UV-cured.

14. The layered structure of claim 1, wherein the coating is from an uncured composition of urethane acrylate blend, alumina nanoparticles, matting agent, light stabilizer, UV absorber, and photo initiator.

15. The layered structure of claim 1, wherein the coating has a thickness between about 0.5 mils and about 10 mils.

16. The layered structure of claim 1, wherein the substrate is selected from the group of materials consisting of polypropylene, polyethylene, and polyvinyl chloride.

17. The layered structure of claim 1, wherein the structure is selected from the group consisting of siding, decking, railing, fencing, trim, and combinations thereof.

18. The layered structure of claim 1, wherein the structure is an exterior structure.

19. A process of applying an image layer, the process comprising:
positioning a substrate; and
applying an image layer to the substrate, the image layer comprising an image formed by a transfer foil process, a digital printing process, or a combination thereof; and
applying a coating to the image layer;
wherein the coating is a radiation-cured, an amine-cured, or a combination thereof.

20. A process of using a layered structure, the process comprising:
positioning the layered structure in an exterior environment, the layered structure comprising a substrate and an image layer applied to the substrate;
applying an image to the image layer by a transfer foil process, a digital printing process, or a combination thereof; and
applying the coating to the image layer, the coating being radiation-cured, amine-cured, or a combination thereof.
